(19) United States
(12) Patent Application Publication
(10) Pub. No.: US 2024/0419323 A1
(43) Pub. Date: Dec. 19, 2024

(54) IMAGE PROCESSING APPARATUS, CONTROL METHOD, AND CONTROL PROGRAM

(71) Applicant: KYOCERA CORPORATION, Kyoto-shi (JP)

(72) Inventors: Hiroshi OKA, Kyoto-shi (JP); Shingo ITO, Kyoto-shi (JP)

(21) Appl. No.: 18/817,150

(22) Filed: Aug. 27, 2024

Related U.S. Application Data
(63) Continuation of application No. PCT/JP2022/008328, filed on Feb. 28, 2022.

(51) Int. Cl. G06F 3/04886; G06F 3/0482; G06F 3/0484

(52) U.S. Cl. CPC G06F 3/04886; G06F 3/0482; G06F 3/0484; G06F 2203/04803

(57) ABSTRACT

An image processing apparatus includes an image processor configured to execute image processing using at least one selected from the group consisting of image printing, image scanning, and image data communication, a display having a touch panel function and configured to display an operation screen including a first display region and a second display region in which display contents related to the image processing are different from each other, a detector configured to detect a position and a pressure level of a touch operation on the display and configured to detect the pressure level in a stepwise manner, and a controller configured to assign, to the first display region, and assign, to the second display region.

### RELATED APPLICATION

The present application is a continuation of PCT Application No. PCT/JP2022/008328, filed on Feb. 28, 2022, the content of which is incorporated by reference herein in its entirety.

### TECHNICAL FIELD

The disclosure relates to an image processing apparatus, a control method, and a control program.

### BACKGROUND

Heretofore, there is known an image processing apparatus including a display that has a touch panel function and displays an operation screen related to image processing. As such an image processing apparatus, Patent Document 1 discloses an image processing apparatus that detects a touch position and a touch intensity, and changes a function to be executed depending on whether the detected touch intensity is larger than a threshold. According to this image processing apparatus, a plurality of functions can be executed by one button, and operability can be improved.

### CITATION LIST

### Patent Literature

Patent Document 1: JP 2012-43214 A

### SUMMARY

In a first aspect, an image processing apparatus includes an image processor configured to execute image processing using at least one selected from the group consisting of image printing, image scanning, and image data communication, a display having a touch panel function and configured to display an operation screen comprising a first display region and a second display region in which display contents related to the image processing are different from each other, a detector configured to detect a position and a pressure level of a touch operation on the display and configured to detect the pressure level in a stepwise manner, and a controller configured to assign, to the first display region, a single-input mode in which an acceptable pressure level of the touch operation is set at a single level, and assign, to the second display region, a multi-input mode in which an acceptable pressure level of the touch operation is set at a plurality of levels.

In a second aspect, a control method is for controlling an image processing apparatus configured to execute image processing using at least one selected from the group consisting of image printing, image scanning, and image data communication. The control method includes assigning, to a first display region, a single-input mode in which an acceptable pressure level of a touch operation is set at a single level, assigning, to a second display region, a multi-input mode in which an acceptable pressure level of the touch operation is set at a plurality of levels, displaying, by a display having a touch panel function, an operation screen comprising the first display region and the second display region in which display contents related to the image processing are different from each other, and detecting, by a detector configured to detect a pressure level in a stepwise manner, a position and the pressure level of a touch operation on the display.

In a third aspect, a program causes an image processing apparatus configured to execute image processing using at least one selected from the group consisting of image printing, image scanning, and image data communication to execute assigning, to a first display region, a single-input mode in which an acceptable pressure level of a touch operation is set at a single level, assigning, to a second display region, a multi-input mode in which an acceptable pressure level of the touch operation is set at a plurality of levels, displaying, by a display having a touch panel function, an operation screen comprising the first display region and the second display region in which display contents related to the image processing are different from each other, and detecting, by a detector configured to detect a pressure level in a stepwise manner, a position and the pressure level of a touch operation on the display.

### BRIEF DESCRIPTION OF THE DRAWINGS

FIG. 1 is a diagram illustrating a functional block configuration of an image processing apparatus according to an embodiment.

FIG. 2 is a diagram illustrating an external appearance configuration example of the image processing apparatus according to the embodiment.

FIG. 3 is a diagram for explaining a touch panel display according to the embodiment.

FIG. 4 is a diagram illustrating an operation example of the image processing apparatus according to the embodiment.

FIG. 5 is a diagram illustrating a home screen display example in the image processing apparatus according to the embodiment.

FIG. 6 is a diagram illustrating a copy screen display example in the image processing apparatus according to the embodiment.

FIG. 7 is a diagram illustrating a display operation example at the time of a weak touch operation in a history display region according to the embodiment.

FIG. 8 is a diagram illustrating a first display operation at the time of a strong touch operation in the history display region according to the embodiment.

FIG. 9 is a diagram illustrating a second display operation at the time of the strong touch operation in the history display region according to the embodiment.

FIG. 10 is a diagram illustrating a third display operation at the time of the strong touch operation in the history display region according to the embodiment.

FIG. 11 is a diagram illustrating a fourth display operation at the time of the strong touch operation in the history display region according to the embodiment.

FIG. 12 is a diagram illustrating a fifth display operation at the time of the strong touch operation in the history display region according to the embodiment.

### DESCRIPTION OF EMBODIMENTS

In an embodiment, an image processing apparatus is described with reference to the drawings. In the description of the drawings, the same or similar parts are denoted by the same or similar reference signs.

### (1) Overview of Embodiment

An overview of the embodiment is described first. As described above, a mode in which an acceptable pressure level of a touch operation is set to include a plurality of levels (hereinafter, referred to as a “multi-input mode”) can improve operability for a user who is accustomed to the multi-input mode or a user who is familiar with an operation of an image processing apparatus. However, for a user who is not accustomed to the multi-input mode or a user who is not familiar with the operation of the image processing apparatus, a concern exists in that the use of the multi-input mode rather impairs the operability.

In the following embodiment, an image processing apparatus capable of further improving user operability is described.

An image processing apparatus according to an embodiment includes an image processor configured to execute image processing using at least one selected from the group consisting of image printing, image scanning, and image data communication, a display having a touch panel function and configured to display an operation screen comprising a first display region and a second display region, the first display region and the second display region containing display contents different from each other related to the image processing, a detector configured to detect a position and a pressure level of a touch operation performed on the display and configured to detecting the pressure level in a stepwise manner, and a controller configured to assign, to the first display region, a single-input mode in which a single level is set for an acceptable pressure level of the touch operation, and assign, to the second display region, a multi-input mode in which a plurality of levels are set for the acceptable pressure level of the touch operation.

As described above, the operation screen includes the first display region to which the single-input mode is assigned and the second display region to which the multi-input mode is assigned, and the display contents related to the image processing are made different between the first display region and the second display region. This allows even a user who is not accustomed to the multi-input mode or a user who is not familiar with the operation of the image processing apparatus to smoothly operate the image processing apparatus using the first display region, mitigating the operability impairment. A user who is accustomed to the multi-input mode or a user who is familiar with the operation of the image processing apparatus can achieve an advanced operation using the second display region, improving the operability. The assigning of an appropriate input mode to each display region can easily maintain the good operability even when the operation screen becomes complicated. Therefore, in the embodiment, the image processing apparatus can further improve the user operability.

### (2) Configuration of Image Processing Apparatus

In the embodiment, a configuration of the image processing apparatus is described.

### (2.1) General Configuration of Image Processing Apparatus

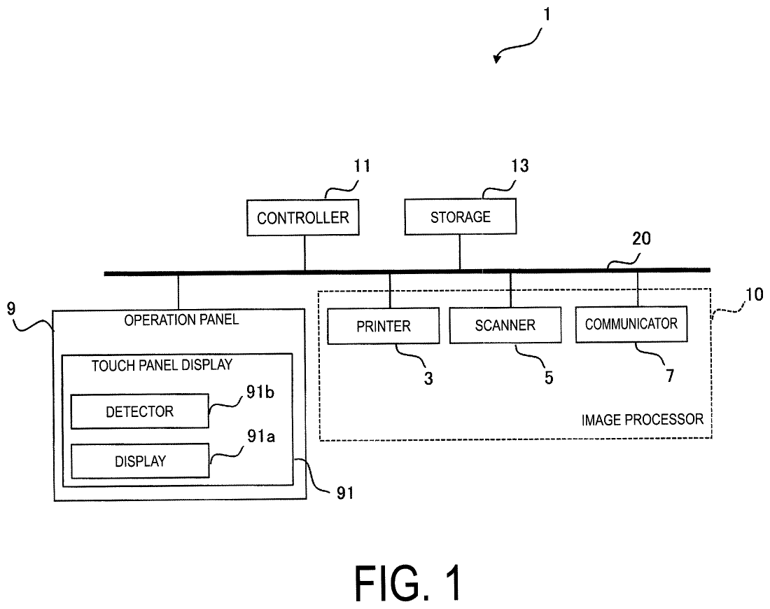

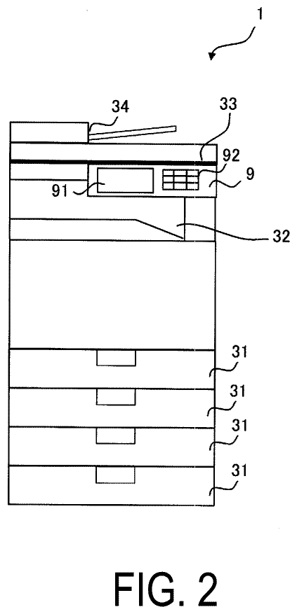

FIG. 1 is a diagram illustrating a functional block configuration of an image processing apparatus 1 according to the embodiment. FIG. 2 is a diagram illustrating an external appearance configuration example of the image processing apparatus 1 according to the embodiment.

As illustrated in FIG. 1, the image processing apparatus 1 includes a printer 3, a scanner 5, a communicator 7, an operation panel 9, a controller 11, and a storage 13. In the embodiment, the printer 3, the scanner 5, and the communicator 7 constitute an image processor 10.

In the embodiment, the image processing apparatus 1 includes the operation panel 9 and is configured to be capable of executing one or more types of image processing. In the embodiment, the printer 3, the scanner 5, and the communicator 7 are provided as a configuration for executing the image processing. However, only one of the printer 3 and the scanner 5 may be provided in an aspect, or the communicator 7 may not need to be provided in another aspect.

The image processor 10 executes the image processing using at least one selected from the group consisting of the image printing, the image scanning, and the image data communication. For example, the types of image processing include “print”, “copy”, “scan”, and “facsimile (FAX)”. The type “copy” refers to a function of allowing an image scanned by the scanner 5 to be printed on a paper sheet in the printer 3. The type “print” refers to a function of allowing an image based on data externally received by the communicator 7 or an image based on data stored in a recording medium (not illustrated) connected to the image processing apparatus 1 to be printed in the printer 3. The type “scan” refers to a function of storing an image scanned by the scanner 5 as data. For example, a storage destination is an auxiliary storage device (a non-volatile memory from another viewpoint) included in the storage 13, a storage medium connected to the image processing apparatus 1, or another device that performs communication with the image processing apparatus 1 via the communicator 7. The type “FAX” refers to a function of allowing data externally received by the communicator 7 via a telephone line to be printed on a paper sheet in the printer 3, and a function of allowing image data scanned by the scanner 5 to be externally transmitted from the communicator 7 via the telephone line.

The image processor 10 may not need to support to all functions (image processing) of printing, copying, scanning, and FAX. The image processor 10 may support only one or only two of the functions of printing, copying, scanning, and FAX, for example. The image processor 10 may support functions other than printing, copying, scanning, and FAX, for example, “email”. The type “email” refers to a function of performing setting and/or execution related to an email. With this function, for example, a part or all of the contents of an email received by the communicator 7 may be printed by the printer 3, or data of an image scanned by the scanner 5 may be transmitted by the communicator 7 via an email.

Note that the “image” may include only characters. The format of the “image data” may be various, and may be, for example, a vector format or a raster format. In the description of the embodiment, “image” and “image data” may not be strictly distinguished from each other for the sake of convenience. The “image data” may be converted into an appropriate format in the course of the image processing. For example, the image data stored in the image processing apparatus 1 may be different in format from image data when the image processing (e.g., printing or FAX) is executed. However, in the description of the embodiment, a description of such format conversion is omitted, and the image data before and after conversion may be described as the same image data, for the sake of convenience. The image data may be modified such that image quality is changed or a part of the image is cut out when the image processing is executed. In the case like this also, in the description of the embodiment, the image data may not be strictly distinguished from each other before and after conversion, for the sake of convenience.

The printer 3 performs image printing under control of the controller 11. For example, the printer 3 performs printing on a paper sheet housed in the sheet feed tray 31 illustrated in FIG. 2, and discharges a printed paper sheet to the sheet discharge tray 32. The printer 3 may include only one sheet feed tray 31 or a plurality of sheet feed trays 31. The plurality of sheet feed trays 31 contribute to, for example, housing paper sheets of different sizes. From another viewpoint, the printer 3 may have a function of selecting a size of a paper sheet. The printer 3 may be configured to be capable of color (and monochrome and gray scale) printing, may be configured to be capable of only grayscale (and monochrome) printing, or may be configured to be capable of only monochrome printing.

The scanner 5 performs image scanning under control of the controller 11. The scanner 5 images (scans) an original document set on a scanner bed 33 or an Auto Document Feeder (ADF) 34 illustrated in FIG. 2 by an imaging device that moves along a document glass to generate image data.

The communicator 7 performs image data communication under control of the controller 11. Specifically, the communicator 7 achieves communication between the image processing apparatus 1 and another apparatus. Examples of the other apparatus include a personal computer (PC), a mobile terminal (such as a smartphone), another image processing apparatus, and a server. Examples of the server include a file server, a mail server, and a Web server. The communication may be performed directly or indirectly via a network with the other apparatus. Examples of the network include a telephone network, the Internet, a private network, and a local area network (LAN). The communication may be a wired communication or a wireless communication. The image processing apparatus 1 may be configured to be capable of one or more arbitrary communications among the various communications described above. Although not particularly illustrated, the communicator 7 includes various components for achieving the various communications described above. The communicator 7 may be considered to include only a hardware configuration (e.g., a connector, an antenna, an amplifier, a filter, and a radio frequency (RF) circuit), or include a software configuration in addition to the hardware configuration.

The operation panel 9 constitutes an operation inputter receiving a user operation (user input). The operation panel 9 includes a touch panel display 91. The touch panel display 91 is an example of a display having a touch panel function. The operation panel 9 may include one or more physical buttons 92 as illustrated in FIG. 2.

The touch panel display 91 includes a display 91a displaying an image under control of the controller 11, and a detector 91b detecting a position and a pressure level of a touch operation performed on the display 91a.

For example, the display 91a includes a liquid crystal display or an organic electroluminescence (EL) display. These displays include a relatively large number of pixels regularly arranged, and can display an image including an arbitrary shape based on image data. The display 91a may be capable of displaying a color image, may be capable of displaying only a grayscale image (and a monochrome image), or may be capable of displaying only a monochrome image (a binary image).

The detector 91b detects the position and the pressure level of the touch operation performed on the display 91a, and outputs detection results to the controller 11. The detector 91b may include a touch panel overlapping the display 91a and an analog-to-digital (A/D) converter that performs A/D conversion on an output of the touch panel. In the embodiment, the detector 91b is configured to be capable of detecting the pressure level of the touch operation in a stepwise manner. The detector 91b may be electrostatic or pressure-sensitive. The electrostatic type detects a change in capacitance on and/or in the vicinity of the screen caused by contact or proximity of a finger or a pen. The pressure-sensitive type detects a pressure applied to the screen. Besides these, the detector 91b may be those using surface acoustic waves, infrared lights, or electromagnetic induction.

The controller 11 includes one or more processors, and controls the entire image processing apparatus 1. The controller 11 executes various types of processing by executing a control program stored in the storage 13. The controller 11 controls operations of the printer 3, the scanner 5, the communicator 7, and the operation panel 9. For example, when the controller 11 receives an operation (instruction) of the user via the operation panel 9, the controller 11 executes processing depending on contents of the operation. The operation panel 9 displays various operation screens on the touch panel display 91 in accordance with an instruction from the controller 11. Note that the controller 11 may include a logic circuit configured to perform only a certain operation.

For example, the storage 13 includes various memories such as a read only memory (ROM), a random access memory (RAM), and an auxiliary storage device. Note that a combination of the controller 11 and the storage 13 may be considered as a computer. The program to be executed by the controller 11 is stored in the ROM and/or the auxiliary storage device of the storage 13, for example.

The printer 3, the scanner 5, the communicator 7, the operation panel 9, the controller 11, and the storage 13 are connected by a bus 20, for example. In FIG. 1, all of the components are schematically connected to one bus 20, but a plurality of buses may be present. For example, an address bus, a data bus, and a control bus may be provided. An interface may be interposed between the bus 20 and respective components (3, 5, 7, and 9).

FIG. 1 is merely a schematic view. For example, a plurality of controllers 11 and storages 13 may be provided in a distributed manner. For example, a processor included in the component(s) (3, 5, 7, and/or 9) (a controller that controls each component from another viewpoint) and a higher layer processor thereof (a higher layer controller that controls the controller of each component) may be provided. In such a case, the controller 11 may be considered as the higher layer controller, or may be considered as a combination of the controller of each component and the higher layer controller. As is understood from the above, the controller 11 may not need to be clearly distinguishable from the component(s) (3, 5, 7, and/or 9).

FIG. 2 illustrates, as an external appearance of the image processing apparatus 1, an external appearance of a multifunction peripheral for business use. However, the image processing apparatus 1 may be used in any manner. For example, the image processing apparatus 1 may be installed at home and used homely or individually, may be installed in a company and used by a plurality of specific users, or may be installed in a store, such as a convenience store, and used by a plurality of unspecified users.

### (2.2) Touch Panel Display

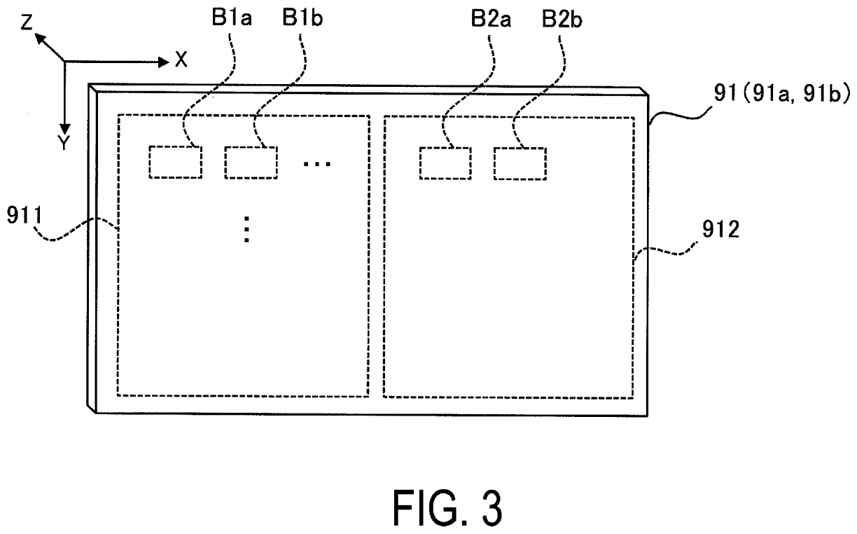

FIG. 3 is a diagram for explaining the touch panel display 91 according to the embodiment.

As described above, the touch panel display 91 includes, for example, the display 91a (display panel) and the detector 91b (touch panel) disposed to overlap an upper surface of the display 91a. The user can visually recognize the display contents of the display 91a through the touch panel.

When an arbitrary position on the touch panel display 91 is touched (pressed), the detector 91b generates an analog voltage value which is a continuous value corresponding to a pressed position in X and Y directions and a pressing pressure in a Z direction. The pressing pressure indicates a degree of pressing on the touch panel display 91. The pressing pressure can be detected by using, for example, a resistance value acquired from the touch panel display 91, a capacitance detection value acquired from the touch panel display 91, or the like in accordance with the touch panel system.

For the Z direction, since the pressing force is generally difficult for the user to accurately change for each of several levels or more, assume three stepwise levels of a non-touch state (not pressed), a pressure level L (lightly pressed), and a pressure level H (strongly pressed). The pressure level L is a state in which the pressure level of the touch operation is lower than a threshold (predetermined level), and the pressure level H is a state in which the pressure level of the touch operation is equal to or higher than the threshold (predetermined level). In the description of the embodiment, the touch operation at the pressure level L may be referred to as a “weak touch operation”, and the touch operation at the pressure level H may be referred to as a “strong touch operation”. Note that whether the values in the X, Y, and Z directions can be read at the same time or any of the values can be read by setting depends on the configuration of the touch panel display 91.

The detector 91b converts the generated analog voltage value into digital data and outputs the resulting digital data to the controller 11. The controller 11 receives the digital data in the X, Y, and Z directions from the detector 91b and acquires coordinate values in the X, Y, and Z directions.

In the embodiment, the display 91a of the touch panel display 91 displays an operation screen including a first display region 911 and a second display region 912 which contain display contents different from each other related to the image processing. Although FIG. 3 illustrates an example in which the operation screen is divided into left and right halves to form the first display region 911 and the second display region 912, the operation screen may be divided into upper and lower halves to form the first display region 911 and the second display region 912. The operation screen may be divided into three or more.

The operation screen including the first display region 911 and the second display region 912 may be a home screen. The home screen is, for example, a screen displayed when the user starts using the image processing apparatus 1. From another point of view, the home screen is a screen that is started up when the image processing apparatus 1 is powered on, when the image processing apparatus 1 returns from the sleep mode, and/or when user authentication is successful in the image processing apparatus 1. However, the operation screen including the first display region 911 and the second display region 912 may be a screen other than the home screen.

The first display region 911 displays one or more buttons B1 (B1a, B1b, and so on) for receiving user operations. The second display region 912 displays one or more buttons B2 (B2a, B2b, and so on) for receiving user operations. The button B1 and information displayed on the button B1 may be a text or a symbol image. In the description of the embodiment, for example, when information is displayed on the operation panel 9 or a part (button or the like) displayed on the operation panel 9 includes information, the information may be displayed by a text and/or a symbol image unless a contradiction or the like particularly occurs. The “text” may refer to, for example, information displayed as a character string and/or information displayed based on text data. Therefore, for example, the text may be a character string displayed based on the image data, or may be a sign or only one character displayed based on the text data. The “symbol image” may refer to, for example, information displayed as a sign, a figure, or the like and/or information displayed based on image data. Therefore, for example, the symbol image may be a sign displayed based on text data, or may be one or more characters displayed based on image data. As understood from the above description, the text and the symbol image may be classified to partially overlap with each other. The “button” may not need to imitate the physical button 92. For example, a button may be indicated only by a text and/or a symbol image and may not need to have a border surrounding the text and/or the symbol image. From another point of view, for example, a boundary between an area in which the user's operation is detected and a surrounding area may not need to be represented by a frame line or a difference in color. In the description of the embodiment, terms indicating specific aspects such as “press”, “touch”, and “tap” may be used for the “operations” performed on the operation panel 9 for the sake of convenience. However, these terms may be contained in generic concept with the “predetermined operation”.

The controller 11 assigns the single-input mode to the first display region 911, the acceptable pressure level of the touch operation being set to include a single level in the single-input mode. In other words, the controller 11 sets the single-input mode to the first display region 911. For example, the controller 11 may control the detector 91b to detect two stepwise levels of the non-touch state (not pressed) and a touch state (pressed state) for the first display region 911. The controller 11 may receive three stepwise signals of the non-touch state, the pressure level L, and the pressure level H from the detector 91b, and collectively interpret the pressure level L and the pressure level H as the touch state (pressed state) for the first display region 911.

The controller 11 assigns the multi-input mode to the second display region 912, the acceptable pressure level of the touch operation being set to include a plurality of levels in the multi-input mode. In other words, the controller 11 sets the multi-input mode to the second display region 912. For example, the controller 11 may control the detector 91b to detect three stepwise levels of the non-touch state (not pressed), the pressure level L (lightly pressed), and the pressure level H (strongly pressed) for the second display region 912.

Accordingly, for the operation screen including the first display region 911 and the second display region 912 which contain the display contents different from each other related to the image processing, the input modes can be made different from each other for the first display region 911 and the second display region 912. Therefore, even a user who is not accustomed to the multi-input mode or a user who is not familiar with the operation of the image processing apparatus 1 can smoothly operate the image processing apparatus using the first display region 911, mitigating the operability impairment. From such a viewpoint, the first display region 911 is preferably a region in which buttons for performing basic operations on the image processing apparatus 1 are arranged. On the other hand, a user who is accustomed to the multi-input mode or a user who is familiar with the operation of the image processing apparatus 1 can achieve an advanced operation using the second display region 912, improving the operability. From such a viewpoint, the second display region 912 is preferably a region in which buttons for performing applicable operations on the image processing apparatus 1 are arranged.

When the detector 91b detects the touch operation performed on the button B2 in the second display region 912, the controller 11 controls the display 91a to perform a display operation, among a plurality of display operations set for the respective pressure levels, corresponding to the pressure level of the detected touch operation. To be more specific, when the button B2 in the second display region 912 is operated, the controller 11 controls the display 91a to perform different display operations depending on whether the pressure level is the pressure level L or the pressure level H. Thus, the plurality of display operations can be assigned to one button, improving the operability. The limited display regions are also easy to effectively utilize. Specific examples of the display operations are described below.

### (3) Operation Example of Image Processing Apparatus

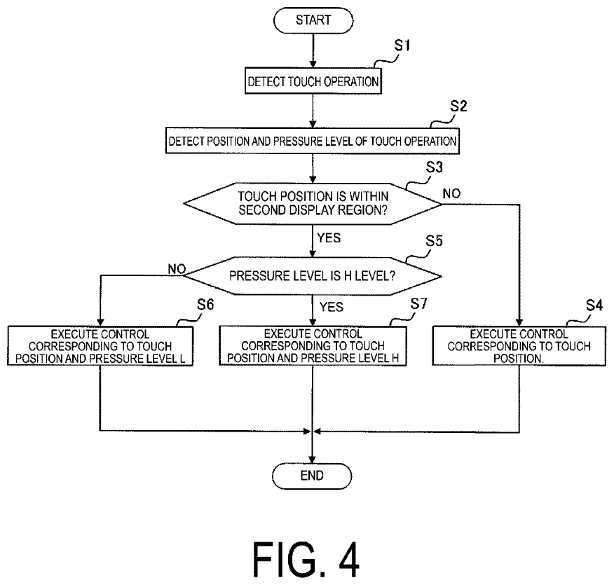

In the embodiment, an operation example of the image processing apparatus 1 is described. FIG. 4 is a diagram illustrating the operation example of the image processing apparatus 1 according to the embodiment.

In step S1, the detector 91b detects a touch operation. To be specific, when the user touches (presses or taps) a button displayed on the display 91a, the detector 91b detects the touch operation depending on a change in the analog voltage value.

In step S2, the detector 91b detects the analog voltage values in the X, Y, and Z directions, and obtains coordinate values on the display 91a from these values. For example, upon detecting the coordinates in the X, Y, and Z directions using the A/D converter, the detector 91b switches to a detection path corresponding to each of the detection directions to connect to the A/D converter and detects analog voltage values in the detection directions. As described above, the Z coordinate has three stepwise values of the non-touch state (not pressed), the pressure level L (lightly pressed), and the pressure level H (strongly pressed). The detector 91b outputs the X, Y, and Z coordinate values of the touch operation to the controller 11.

In step S3, the controller 11 compares the X and Y coordinate values of the touch operation (i.e., the touch position) with the coordinate values indicating a range of the second display region 912 to determine whether the X and Y coordinate values of the touch operation are within the second display region 912.

When the X and Y coordinate values of the touch operation are determined to be not within the second display region 912, that is, the X and Y coordinate values of the touch operation are determined to be within the first display region 911 (step S3: NO), in step S4, the controller 11 controls the display 91a to perform the display operation corresponding to the X and Y coordinate values of the touch operation regardless of the Z coordinate value of the touch operation. For example, when the X and Y coordinate values of the touch operation correspond to a displayed position of any button B1 within the first display region 911, the controller 11 performs the display operation assigned to the button B1. Note that when the button B1 is a button for receiving an operation of instructing to execute any image processing, the controller 11 may control the image processor 10 to execute the instructed image processing.

On the other hand, when the X and Y coordinate values of the touch operation are determined to be within the second display region 912 (step S3: YES), in step S5, the controller 11 determines whether the Z coordinate value of the touch operation (i.e., the pressure level) is the H level.

When the Z coordinate value (pressure level) of the touch operation is determined to be not the H level, that is, to be the L level (step S5: NO), in step S6, the controller 11 controls the display 91a to perform the display operation corresponding to the X and Y coordinate values (touch position) and the pressure level L of the touch operation. For example, when the X and Y coordinate values of the touch operation correspond to a displayed position of any button B2 within the second display region 912, the controller 11 performs the display operation corresponding to the pressure level L among the plurality of display operations assigned to the button B2.

When the Z coordinate value (pressure level) of the touch operation is determined to be the H level (step S5: YES), in step S7, the controller 11 controls the display 91a to perform the display operation corresponding to the X and Y coordinate values (touch position) and the pressure level H of the touch operation. For example, when the X and Y coordinate values of the touch operation correspond to a displayed position of any button B2 within the second display region 912, the controller 11 the display operation corresponding to the pressure level H among the plurality of display operations assigned to the button B2.

### (4) Display Operation Example

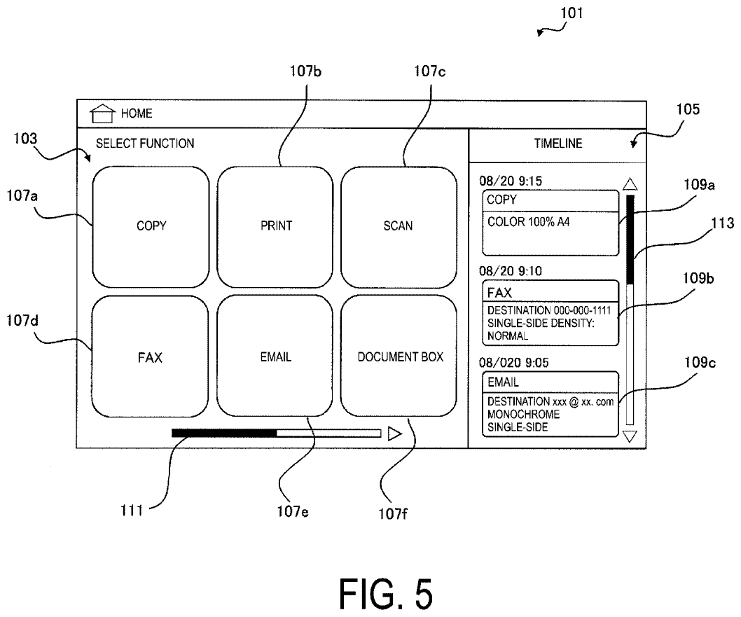

In the embodiment, a display operation example of the image processing apparatus 1 is described. FIG. 5 is a diagram illustrating the display operation example of the image processing apparatus 1 according to the embodiment. Hereinafter, an example in which the operation screen displayed by the display 91a is a home screen 101 is described.

The home screen 101 includes a menu area 103 in which a plurality of function buttons 107 (107a, 107b, and so on) corresponding to the types of image processing are arranged, and a history display region 105 including a plurality of history buttons 109 (109a, 109b, and so on) indicating a history of the image processing executed in the past. Note that the menu area 103 may be referred to as a main display region. The history display region 105 may be referred to as a timeline display region.

In the embodiment, the menu area 103 is the first display region 911. That is, the single-input mode is assigned to the menu area 103. Since the menu area 103 is an area in which the function buttons 107 for performing the basic operations on the image processing apparatus 1 are arranged, even a user who is not accustomed to the multi-input mode or a user who is not familiar with the operation of the image processing apparatus 1 can smoothly operate the image processing apparatus using the menu area 103.

In the embodiment, the history display region 105 is the second display region 912. That is, the multi-input mode is assigned to the history display region 105. Since the history display region 105 is an area in which the history buttons 109 for performing the applicable operation on the image processing apparatus 1 are arranged, a user who is accustomed to the multi-input mode or a user who is familiar with the operation of the image processing apparatus 1 can achieve a high-level operation using the history display region 105, improving the operability.

### (4.1) Menu Area

The menu area 103 includes the plurality of function buttons 107 (107a, 107b, and so on) corresponding to the types of image processing (in the example of FIG. 5, “copy”, “print”, “scan”, “FAX”, “email”, and “document box”). The menu area 103 may be scrollable by a scroll bar 111. Although an example is illustrated in which a scroll direction is a right-left direction, the scroll direction may be a top-bottom direction.

The number of function buttons 107 and kinds of functions corresponding to the function buttons 107 may be set as appropriate. Hereinafter, each function button 107 may be indicated by a text displayed in the function button 107. The same applies to other buttons. In FIG. 5, the function buttons 107 are illustrated as a copy button 107a, a print button 107b, a scan button 107c, a FAX button 107d, an email button 107e, and a document box button 107f.

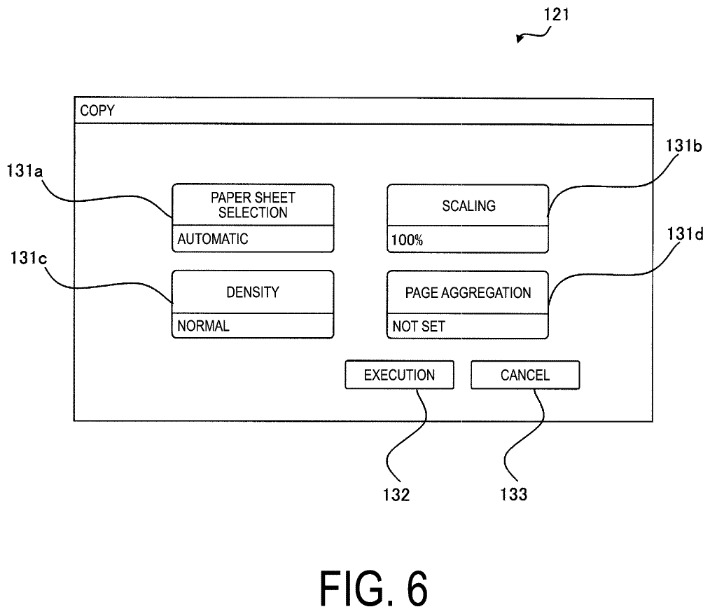

When any one of the function buttons 107 in the menu area 103 of the home screen 101 is tapped, the controller 11 controls the display 91a to switch the screen displayed on the display 91a to a screen for performing an operation related to a function corresponding to the function button 107. For example, when the copy button 107a is tapped, the controller 11 controls the display 91a to switch from the home screen 101 to a copy screen 121 illustrated in FIG. 6.

The copy screen 121 includes a plurality of setting buttons 131 (131a, 131b, and so on) for setting image processing conditions (here, copy conditions), an execution button 132 for instructing to execute copying, and a cancel button (return button from another viewpoint) 133 for returning to the home screen 101. Note that when the physical button 92 is provided with the execution button 132 and/or a cancel button (return button), the execution button 132 and/or the cancel button (return button) 133 may not need to be displayed.

The number and kinds of setting buttons 131 are arbitrary. In the example of FIG. 6, the setting buttons 131 include a paper sheet selection button 131a, a scaling button 131b, a density button 131c, and a page aggregation button 131d. Since these are general ones, descriptions thereof are omitted. The controller 11 sets the copy conditions depending on operations performed on the setting buttons 131. Then, when the execution button 132 is tapped, the controller 11 controls the image processor 10 to execute copying. When a button for returning to the home screen 101 is tapped or a certain period of time elapses, the controller 11 controls the display 91a to switch from the copy screen 121 to the home screen 101.

Unlike the above description, the controller 11 may control the image processor 10 to execute the image processing (e.g., copying) when any function button 107 is tapped. The condition of the image processing (e.g., the processing condition of copying) may be set on a dedicated screen for setting the processing condition, the dedicated screen being displayed by tapping the dedicated function button 107 for setting the processing condition.

### (4.2) History Display Region

As illustrated in FIG. 5, the history display region 105 is a display region for displaying a history of the image processing executed in the past.

A position, shape, and area of the history display region 105 are arbitrary. In the example of FIG. 5, the history display region 105 is located on one side (right side in the illustrated example) of the home screen 101, the home screen 101 having a rectangular shape with a longitudinal direction thereof corresponding to the right-left direction, the history display region 105 having a rectangular shape with a longitudinal direction thereof corresponding to the top-bottom direction. A width of the history display region 105 is less than one half or less than one third of a width of the home screen 101. Note that most (e.g., 80% or more) of the home screen 101 excluding the history display region 105 is the menu area 103. The history display region 105 may be scrollable by a scroll bar 113. Although an example is illustrated in which a scroll direction is the top-bottom direction, the scroll direction may be the right-left direction.

The maximum number of history buttons 109 that can be displayed by scrolling in the history display region 105 is predetermined. For example, in the history display region 105, the history buttons 109 up to the most recent N jobs (N≥2) among image processing jobs executed in the past can be displayed.

The plurality of history buttons 109 (109a, 109b, and so on) are lined up in one row in a predetermined direction in the order of a date and time when the image processing corresponding to the history button 109 has been executed, for example. The plurality of history buttons 109 may be lined up in any direction. The plurality of history buttons 109 may be lined up from one side to the other side in a lining-up direction (from a top side to a bottom side in the illustrated example) in chronological descending order (the illustrated example) or in chronological ascending order, or the chronological descending and ascending orders may be switched to each other by performing a predetermined operation on the operation panel 9. Note that assume that the chronological descending order is used in the description of the embodiment for the sake of convenience.

When image processing is executed via an operation performed on the function button 107 or via an operation performed on the history button 109 (and the execution button 132 (FIG. 6)), the controller 11 adds a new history button 109 related to the image processing. When the image processing based on which the history button 109 is added is the same as the new image processing executed via the operation performed on the relevant history button 109, a new history button 109 may be added, or the execution date and time of the image processing corresponding to the operated history button 109 may only be updated (from another viewpoint, the displayed position of the history button 109 is changed). The image processing being the same here may mean, for example, that the image processing is the same except for the execution date and time. However, there may be a difference other than the execution date and time. Note that the history button 109 may not need to be added for image processing executed via an operation performed on the history button 109 unlike the description of the embodiment.

The type of image processing for which the history button 109 is generated is arbitrary. For example, even when the image processing apparatus 1 has the six functions illustrated in the menu area 103, the history buttons 109 may need to be generated for all of these functions. For example, the history button 109 may be generated only for the image processing in which printing is performed in the image processing apparatus 1, such as “copy” and “print” (and printing in “document box”). For example, the history button 109 may be generated only for the image processing in which scanning is performed in the image processing apparatus 1, such as “copy” and “scan”, “FAX”, and “email”. For example, the history button 109 may be generated only for the image processing in which communication is not performed, such as “copy”, “print”, and “scan” (and printing in “document box”).

The history button 109 may or may not need to be added for image processing in which signals including a print job or the like is transmitted from another device (e.g., a PC) to the communicator 7. If the history button 109 is added, for example, a user who transmits a print job from a PC to the image processing apparatus 1 and confirms that printing is failed in front of the image processing apparatus 1 can perform reprinting via the history button 109.

As described above, the number of history buttons 109 provided in the history display region 105 is limited to a predetermined upper limit value or less. In other words, the number of history buttons 109 (including those displayed by scrolling) that can be displayed in the history display region 105 is limited to the predetermined upper limit value or less. Therefore, for example, as described above, after the history button 109 is added and the number of history buttons 109 reaches the upper limit value, when a new history button 109 is further added, the oldest history button 109 is deleted. In other words, the oldest history button 109 cannot be displayed. Note that a specific value of the upper limit value is arbitrary, and is, for example, 5, 10, or 20. The upper limit value may be set by the manufacturer of the image processing apparatus 1 and may not be able to be changed by the administrator or the user of the image processing apparatus 1, or may be able to be set by the administrator of the image processing apparatus 1. In an aspect in which a display aspect of the history display region 105 can be made different for each user, the upper limit value may be able to be set by the user.

A display aspect when the number of history buttons 109 does not reach the upper limit value is arbitrary. For example, only the history buttons 109 whose number is less than the upper limit value may be displayed, or the history buttons and dummy history buttons (e.g., the history buttons in which information is not displayed) whose number in total is the upper limit value may be displayed together. In the former aspect, a length of the history display region 105 may or may not need to be changed depending on the number of history buttons 109.

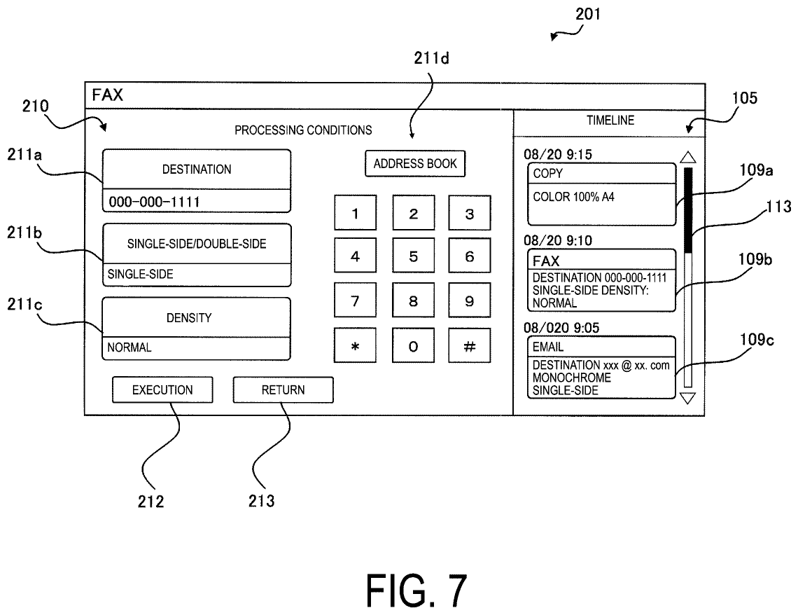

The image processing apparatus 1 may be capable of operations different from those described above regarding addition, deletion, and arrangement of the history button 109. For example, an operation different from the operation for switching to the history use screen 201 (see FIG. 7) (e.g., a long tap or a double tap) may be performed on any history button 109 to not allow the history button 109 to be deleted, to always arrange the history button 109 above the newest history button 109, or to delete the history button 109.

For example, the plurality of history buttons 109 may have the same shape and size as each other (in the illustrated example), or may have different shapes and/or sizes from each other. As an example of the latter, an aspect can be given in which the shapes and/or sizes of the plurality of history buttons 109 are different depending on the types of image processing (difference between copying, scanning, or the like).

Each history button 109 includes (indicates) information of the corresponding image processing. As described above, examples of the information include the date and time when the image processing was executed, the type of the image processing, the condition of the image processing, and the name of the user who executed the image processing. Other examples include a communication destination (a transmission destination and/or a reception destination) in the FAX function and/or the email function. Specifically, each history button 109 indicates at least one piece of information selected from the group consisting of a type of executed image processing executed in the past, a processing condition of the executed image processing, a processing date and time of the executed image processing, an execution username of the executed image processing, and a transmission destination in the executed image processing. Accordingly, the user can easily specify the corresponding executed image processing based on the information indicated by each history button 109.

The information on the image processing may include information on image data handled in the image processing. The information on the image data includes, for example, a size of the image data, a kind of the image determined by the image processing apparatus 1 (whether the image is a document or not), and a name given to the image data by the image processing apparatus 1.

Each history button 109 may display at least one or more of various pieces of information related to the image processing described above (e.g., date and time, type, processing condition, and username). The conditions of the image processing include various specific conditions as illustrated in the description of FIG. 7 described later. In an aspect in which the conditions of the image processing are displayed in the history buttons 109, the specific conditions to be displayed may be selected as appropriate. The history button 109a illustrated in FIG. 5 illustrates a color condition (“color” or “monochrome” is illustrated), a magnification setting (“100%” is illustrated), and a paper sheet condition (“A4” or “automatic” is illustrated).

Kinds of the information on the image processing included in the history buttons 109 (in other words, items displayed on the history buttons 109) may be the same as or different from each other. For example, the kinds of the information displayed on the history buttons 109 may be different depending on the type of image processing. More specifically, for example, the history button 109 of which the type of image processing is copying does not have an item for displaying a communication destination, whereas the history button 109 of which the type of image processing is FAX or email may have an item for displaying a communication destination.

In the history display region 105 configured as described above, when the detector 91b detects a predetermined operation (e.g., a single touch) performed on any of the history buttons 109, the controller 11 controls the display 91a to perform the display operation differently depending on the pressure level. Hereinafter, a display operation example at the time of the weak touch operation (that is, the pressure level L) in the history display region 105 and a display operation example at the time of the strong touch operation (that is, the pressure level H) in the history display region 105 are described.

### (4.2.1) Display Operation at the Time of Weak Touch Operation in History Display Region

FIG. 7 is a diagram illustrating the display operation example at the time of the weak touch operation in the history display region 105 according to the embodiment. Here, assume that the display screen at the time of the weak touch operation is the history use screen 201. In the example of FIG. 7, assume that a weak touch operation performed on the history button 109b related to the FAX executed in the past is detected.

When the detector 91b detects a weak touch operation performed on any of the history buttons 109 in the history display region 105, the controller 11 controls the display 91a to switch to the history use screen 201 for using the history information corresponding to the history button 109.

The history use screen 201 is a screen used for setting the image processing condition to be applied at the present time, the history use screen 201 including an initial value as a past image processing condition corresponding to the history button on which the weak touch operation performed is detected. The history use screen 201 allows the user to divert past image processing conditions and to smoothly and quickly set image processing conditions to be applied at the present time.

Such a display operation of the history use screen 201 is a general display operation when using the history display region 105. The weak touch operation is substantially synonymous with a tap and is a general user operation method. Therefore, by displaying the history use screen 201 as the display operation at the time of the weak touch operation, the history display region 105 is easy to smoothly use for even a user who is not accustomed to the multi-input mode or a user who is not familiar with the operation of the image processing apparatus 1.

In the example of FIG. 7, the history use screen 201 uses the first display region 911 as the history use area 210 while maintaining the history display region 105 as the second display region 912. That is, the history use screen 201 may be a screen obtained by switching only the first display region 911 from the menu area 103 to the history use area 210 in the home screen 101. This makes it easy to apply the single-input mode to the history use area 210. The user easily confirms whether another history is present that is preferable to the currently selected history by scrolling the history display region 105 while browsing the history use area 210.

The history use area 210 includes, for example, a plurality of setting buttons 211 (211a, 211b, and so on) for setting image processing conditions (here, FAX conditions), an execution button 212 for instructing to execute FAX, and a return button 213 for returning to the home screen 101.

The setting buttons 211 display information indicating kinds of setting items corresponding to themselves. The setting buttons 211 may display information indicating setting states of items corresponding to themselves. In the illustrated example, the kind of the setting item is illustrated on a top side of each setting button 211, and the current setting state of the item is illustrated on a bottom side of each setting button 211. The number and kinds of the setting buttons 211 are arbitrary. In the example of FIG. 7, the setting buttons 211 include a destination button 211a, a single-side/double-side button 211b, a density button 211c, and a destination designation button group 211d. Since these are general ones, descriptions thereof are omitted. In the destination button 211a, the single-side/double-side button 211b, and the density button 211c, the conditions in the FAX executed in the past are displayed as initial values. The user, when diverting these initial values without change, can operate (tap) the execution button 212 to smoothly and quickly achieve FAX under the same conditions as the conditions in the FAX executed in the past.

The user, when changing a part of the conditions in the initial values, operates the corresponding setting button 211 to change the part of the conditions. Then, when the execution button 132 is tapped, the controller 11 controls the image processor 10 to execute FAX under the partially changed conditions. Note that when the button for returning to the home screen 101 is tapped or a certain period of time elapses, the controller 11 controls the display 91a to switch from the copy screen 121 to the home screen 101. The layout of the various portions described above is arbitrary, and FIG. 7 is merely an example.

However, when the history button 109 is selected on the home screen 101 and the screen transitions to the history use screen 201 (immediately after the transition), initial settings of various setting items may be set as appropriate. For example, for the image processing of the same type as the type of the image processing corresponding to the history button 109, the setting when the image processing corresponding to the history button 109 is executed may be set as the initial setting. For the other types of image processing, the setting when the image processing corresponding to the history button 109 is executed may be also set as the initial setting in the item common or similar to the type of the image processing corresponding to the history button 109. Since the settable items (e.g., processing conditions) vary depending on the type of image processing, the number and kinds of setting buttons 211 (in other words, setting items) displayed on the history use screen 201 may vary.

### (4.2.2) Display Operation at the Time of Strong Touch Operation in History Display Region

Hereinafter, first to fifth display operations are described as examples of a display operation at the time of the strong touch operation in the history display region. Any one of the first to fifth display operations may be set as a default display operation for the image processing apparatus 1 as the display operation at the time of the strong touch operation in the history display region.

### (4.2.2.1) First Display Operation

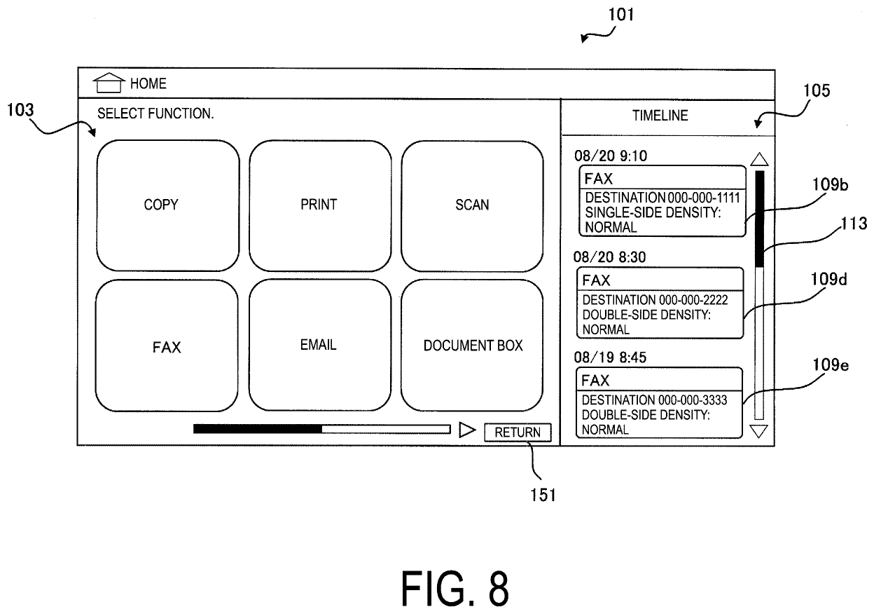

FIG. 8 is a diagram illustrating the first display operation at the time of the strong touch operation in the history display region 105 according to the embodiment. In the example of FIG. 8, assume that a strong touch operation performed on the history button 109b related to the FAX executed in the past is detected in the history display region 105 in the home screen 101 of FIG. 5.

The first display operation is an extraction display operation of displaying, side by side, only the history buttons related to the same type of image processing as the history button 109b touched by the user among the plurality of history buttons 109 in the history display region 105. In the example of FIG. 8, in response to the strong touch operation performed on the history button 109b related to the FAX executed in the past being detected in the history display region 105 in the home screen 101 of FIG. 5, the controller 11 controls the display 91a to display, side by side, the history buttons 109b, 109d, and 109e related to FAX which is the same type of image processing as the history button 109b. For example, when the strong touch operation performed on the history button 109b related to the FAX is detected, the controller 11 extracts the history buttons related to the FAX from all the history buttons 109, and arranges the extracted history buttons in the history display region 105 in time-series order.

Thus, the user intending to cause the image processing apparatus 1 to execute FAX can browse an extracted state of the plurality of history buttons 109b, 109d, and 109e corresponding to the plurality of FAXes executed in the past by performing the strong touch operation on the history button 109b related to the FAX executed in the past. Therefore, the user can smoothly and easily specify a desired history button.

In the example of FIG. 8, the first display operation (extraction display operation) is an operation of displaying, side by side, only the history buttons 109b, 109d, and 109e related to the same type of image processing as the history button 109b strongly touched by the user in the history display region 105 (second display region 912) while maintaining the menu area 103 which is the first display region 911. Accordingly, for example, when the user intending to cause the image processing apparatus 1 to execute FAX cannot find a desired history button related to FAX in the history display region 105, the user can easily switch to an operation on the menu area 103.

The controller 11 may control the display 91a to display a return button 151 for stopping the first display operation (extraction display operation) and returning to the original display (that is, the home screen 101 in FIG. 5). In the example of FIG. 8, the return button 151 is arranged in a bottom portion of the menu area 103 and in the vicinity of the history display region 105. The controller 11, when detecting that the return button 151 is tapped, controls the display 91a to return to the home screen 101 of FIG. 5.

Note that in the described example of this display operation, the strong touch operation performed on the history button 109b related to the FAX executed in the past is detected, but the same and/or similar display operation can be applied to the history button 109 corresponding to the image processing of a type other than FAX. For example, in response to a strong touch operation performed on the history button 109a related to copying executed in the past being detected in the history display region 105 in the home screen 101 of FIG. 5, the controller 11 controls the display 91a to extract the history buttons related to copying which is the same type of image processing as the history button 109a and display the extracted history buttons side by side.

### (4.2.2.2) Second Display Operation

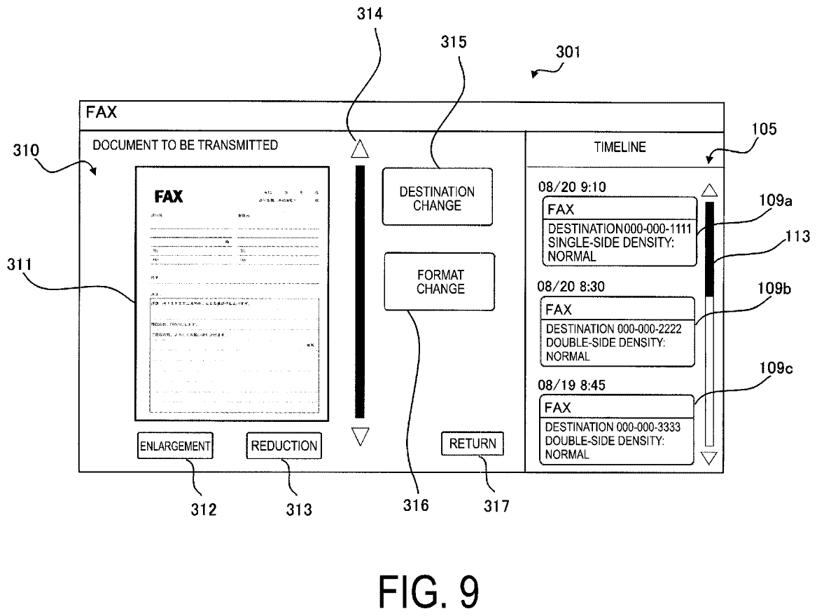

FIG. 9 is a diagram illustrating a second display operation at the time of the strong touch operation in the history display region 105 according to the embodiment. In the example of FIG. 9, assume that a strong touch operation performed on the history button 109b related to the FAX executed in the past is detected in the history display region 105 in the home screen 101 of FIG. 5.

In this operation example, the storage 13 stores data of an image handled in image processing executed in the past. Specifically, the storage 13 stores, for each history button 109, information on a condition of image processing and data of an image handled in the image processing in association with each other. For example, for the history button 109b related to the FAX executed in the past, the storage 13 stores the information on the condition of the FAX and the data of the image transmitted by the FAX in association with each other.

As illustrated in FIG. 9, the second display operation is an image display operation of displaying an image 311 handled in the image processing (here, FAX) corresponding to the history button 109b strongly touched by the user among the images stored in the storage 13. To be more specific, when the detector 91b detects a strong touch operation performed on the history button 109b related to FAX, the controller 11 acquires the data of the image transmitted by the FAX from the storage 13 and controls the display 91a to display the image 311 based on the acquired data. Thus, the user can recognize what image was actually subjected to the image processing (here, FAX transmission) in the past based on the displayed image 311. New image processing (FAX transmission) may be executed on the image 311. In the new image processing, at least a part of the image processing conditions (here, FAX conditions) may be changed.

In the example of FIG. 9, the controller 11 controls the display 91a to display the image display screen 301 in which the image 311 handled in the image processing (here, FAX) corresponding to the history button 109b strongly touched by the user is displayed in an image display region 310. The image display region 310 is provided in the first display region 911. That is, the image display screen 301 may be a screen obtained by switching only the first display region 911 from the menu area 103 to the image display region 310 in the home screen 101. This makes it easy to apply the single-input mode to the image display region 310. The user easily confirms whether another history is present that is preferable to the currently selected history by scrolling the history display region 105 while browsing the image display region 310.

To be more specific, the image display region 310 includes the image 311 handled in the image processing corresponding to the history button 109b strongly touched by the user, an enlargement button 312 for enlarging and displaying the image 311, a reduction button 313 for reducing and displaying the image 311, a scroll bar 314 for scrolling and displaying the image 311, and condition change buttons 315 and 316 for changing the conditions of the image processing. Here, because of the assumption of the type of image processing as FAX, the condition change buttons 315 and 316 include a destination change button 315 for changing the destination of the FAX, a format change button 315 for changing the format of FAX, and a return button 317 for returning to the home screen 101 of FIG. 5. The image display region 310 may further include an execution button for instructing to execute the image processing (FAX transmission) on the image 311.

Note that in the described example of this display operation, the strong touch operation performed on the history button 109b related to the FAX executed in the past is detected, but the same and/or similar display operation can be applied to the history button 109 corresponding to the image processing of a type other than FAX. For example, in response to a strong touch operation performed on the history button 109a related to copying executed in the past being detected in the history display region 105 in the home screen 101 of FIG. 5, the controller 11 acquires an image scanned and printed in the copying from the storage 13 and controls the display 91a to display an image based on the acquired image in the image display region 310.

### (4.2.2.3) Third Display Operation

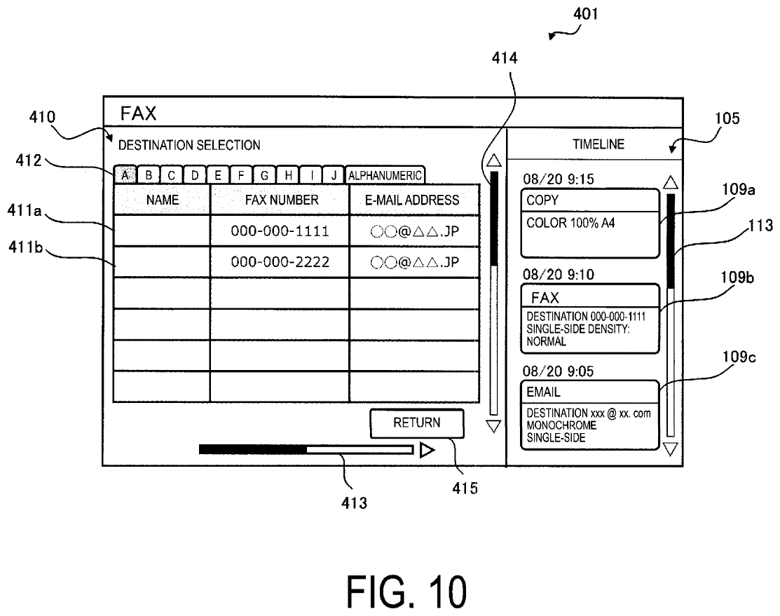

FIG. 10 is a diagram illustrating a third display operation at the time of the strong touch operation in the history display region 105 according to the embodiment. In the example of FIG. 10, assume that a strong touch operation performed on the history button 109b related to the FAX executed in the past is detected in the history display region 105 in the home screen 101 of FIG. 5.

As illustrated in FIG. 10, the third display operation is a display operation of displaying a condition selection screen used for selecting an image processing condition to be applied at the present time among one or more image processing conditions registered in advance for the same type of image processing as the history button 109b strongly touched by the user. Here, because of the assumption of the type of image processing as FAX, assume that the image processing condition is a destination. The controller 11 controls the display 91a to display a destination selection screen 401 used for selecting a destination to be applied at the present time among one or more destinations registered in advance for the FAX which is the type of image processing corresponding to the history button 109b strongly touched by the user. This allows the user to select any one of the destinations displayed on the destination selection screen 401 and perform FAX transmission to the selected destination.

In the example of FIG. 10, the destination selection screen 401 includes a destination selection area 410 provided in the first display region 911. That is, the destination selection screen 401 may be a screen obtained by switching only the first display region 911 from the menu area 103 to the destination selection area 410 in the home screen 101. This makes it easy to apply the single-input mode to the destination selection area 410.

The destination selection area 410 includes entries 411a, 411b, and so on for each destination, and each entry includes a name, a FAX number, and an email address. The user can select a destination by tapping any of the entries 411a, 411b, and so on. The destination selection area 410 includes a plurality of tabs 412 for switching a destination display using an initial character of the name as an index. Furthermore, the destination selection area 410 includes a scroll bar 413 for scrolling in the right-left direction, a scroll bar 414 for scrolling in the top-bottom direction, and a return button 415 for returning to the home screen 101 of FIG. 5.

Note that in the described example of this display operation, the strong touch operation performed on the history button 109b related to the FAX executed in the past is detected, but the same and/or similar display operation can be applied to the history button 109 corresponding to the image processing of a type other than FAX. For example, in response to a strong touch operation performed on the history button 109a related to copying executed in the past being detected in the history display region 105 in the home screen 101 of FIG. 5, the controller 11 controls the display 91a to display a copy condition selection screen used for selecting a copy condition to be applied at the present time from one or more copy conditions (e.g., paper sheet, magnification, density, and/or page aggregation) registered in advance.

### (4.2.2.4) Fourth Display Operation

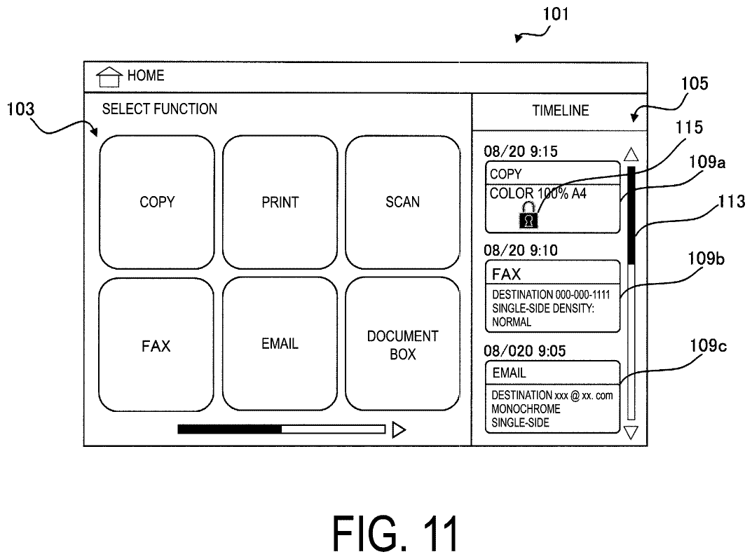

FIG. 11 is a diagram illustrating a fourth display operation at the time of the strong touch operation in the history display region 105 according to the embodiment. In the example of FIG. 11, assume that a strong touch operation performed on the history button 109a related to the copying executed in the past is detected in the history display region 105 in the home screen 101 of FIG. 5.

As illustrated in FIG. 11, the fourth display operation includes any one of an operation of fixing display of the history button 109a strongly touched by the user at a predetermined position (e.g., top position), an operation of releasing the fixing, and an operation of deleting the history button 109a.

FIG. 11 illustrates an example in which a strong touch operation performed on the history button 109a of “copy” at the top in the history display region 105 is detected and the controller 11 fixes the history button 109a at the top position in the history display region 105. For example, the user performs the strong touch operation on the history button 109a which the user frequently uses or desires to use later. This fixes the history button 109a at the top position, and thus the history button 109a can be quickly operated thereafter.

In this case, the controller 11 may control the display 91a to display a symbol image 115 indicating that the history button 109a is fixed (locked) on the history button 109a. When the history button 109a is fixed (locked), the history button 109a may be maintained without being deleted even if the number of image processing jobs of which histories are to be displayed in the history display region 105 (i.e., the number of history buttons 109) exceeds the upper limit value. This can mitigate the problem where the history button 109a desired by the user is deleted.

When the strong touch operation performed on the fixed (locked) history button 109a is detected again, the controller 11 may release the fixing (locking). The controller 11 may rearrange the history buttons 109a of which the fixing (locking) is released in the history display region 105 in time-series order.

The controller 11 may forcibly delete the history button 109 on which the strong touch operation performed is detected. For example, when a strong touch operation performed on the history button 109a of “copy” in the history display region 105 is detected, the controller 11 may delete the history button 109a from the history display region 105. This allows the user to delete a history having a low possibility of reusing the image processing condition later from the history display region 105.

Note that in the described example of this display operation, the strong touch operation performed on the history button 109a related to the copying executed in the past is detected, but the same and/or similar display operation can be applied to the history button 109 corresponding to the image processing of a type other than copying.

### (4.2.2.5) Fifth Display Operation

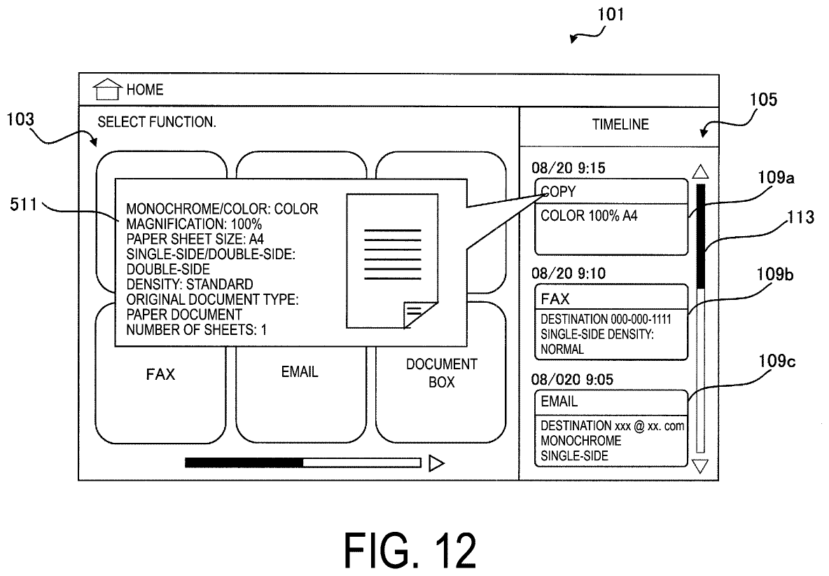

FIG. 12 is a diagram illustrating a fifth display operation at the time of the strong touch operation in the history display region 105 according to the embodiment. In the example of FIG. 12, assume that a strong touch operation performed on the history button 109a related to the copying executed in the past is detected in the history display region 105 in the home screen 101 of FIG. 5.

As illustrated in FIG. 12, the fifth display operation is a detail display operation of displaying detail information 511 indicating a past image processing condition corresponding to the history button 109a strongly touched by the user. FIG. 12 illustrates an example in which in response to the strong touch operation performed on the history button 109a of “copy” at the top in the history display region 105 being detected, the controller 11 displays the detail information 511 of the copy condition corresponding to the history button 109a in a pop-up manner in the first display region 911 (menu area 103). Thus, the user can recognize the detail information of the copy condition corresponding to the history button 109a. Note that in the example illustrated in FIG. 12, the detail information 511 of the copy condition includes “monochrome/color”, “magnification”, “paper sheet size”, “single-side/double-side”, “density”, “original document type”, and “number of sheets”. Since these are general ones, descriptions thereof are omitted.

When a predetermined time elapses after displaying the detail information 511 in the pop-up manner, the controller 11 may end the pop-up display of the detail information 511. The controller 11 may end the pop-up display of the detail information 511 in response to a user operation being performed on a return button (not illustrated). The controller 11 may end the pop-up display of the detail information 511 in response to the strong touch operation performed on the history button 109a being detected again. The controller 11 may maintain the pop-up display of the detail information 511 while the touch state is continuously detected after the strong touch operation is detected, and may end the pop-up display of the detail information 511 in response to release of the touch state being detected.

Note that in the described example of this display operation, the strong touch operation performed on the history button 109a related to the copying executed in the past is detected, but the same and/or similar display operation can be applied to the history button 109 corresponding to the image processing of a type other than copying.

### (5) Other Embodiment

The above-described embodiment assumes that the single-input mode is fixedly assigned to the first display region 911 and the multi-input mode is fixedly assigned to the second display region 912. However, the setting of the correspondence relationship between the display region and the input mode may be changeable based on a user operation. Specifically, the controller 11 may change a setting of whether to assign the multi-input mode or the single-input mode to the first display region 911 and/or the second display region 912, based on the user operation. For example, the display 91a displays a system setting screen and also displays a button for changing the setting of the correspondence relationship between the display region and the input mode. The controller 11 changes the setting of the correspondence relationship between the display region and the input mode depending on the user operation performed on the button. As a result, the controller 11 may change the setting to assign the multi-input mode to the first display region 911. The controller 11 may change the setting to assign the single-input mode to the second display region 912.

In the above-described embodiment, the controller 11 may control the display 91a to display first identification information indicating that the multi-input mode is assigned, in the display region (e.g., second display region 912) to which the multi-input mode is assigned. Thus, the user can recognize that the multi-input mode is assigned to the display region to which the button the user intends to operate belongs, based on the first identification information. The first identification information may be a text or a symbol image. The controller 11 may control the display 91a to display the second identification information indicating the display operation at the time of the strong touch operation in the display region (e.g., second display region 912) to which the multi-input mode is assigned. Thus, the user can recognize what display operation is performed when the strong touch operation is performed on the button the user intends to operate, based on the second identification information. The second identification information may be a text or a symbol image.

In the above-described embodiment, the controller 11 may change the setting of the correspondence relationship between at least one pressure level among the plurality of levels (the pressure level L and the pressure level H) and at least one display operation among the first to fifth display operations described above based on the user operation. For example, the display 91a displays the system setting screen and also displays a button for changing the setting of the correspondence relationship between the pressure level and the display operation. The controller 11 changes the setting of the correspondence relationship between the pressure level and the display operation according to the user operation performed on the button. As a result, the controller 11 may change the setting to assign the display operation selected from the first to fifth display operations to the pressure level L. When the first display operation described above is assigned as a default display operation for the pressure level H, the controller 11 may change the setting to assign the second display operation described above to the pressure level H.

The operational flow of each of the embodiments described above may not need to be executed in time series in the order described in the flow diagram. For example, the steps of operation may be performed in a different order from that described in the flow diagram or may be performed in parallel. Some steps of operation may be omitted and additional steps may be added to the process.

A program that causes the image processing apparatus 1 to execute the operations according to the embodiments described above may be provided. The program may be recorded in a computer readable medium. Use of the computer readable medium enables the program to be installed on a computer (image processing apparatus 1). Here, the computer readable medium on which the program is recorded may be a non-transitory recording medium. The non-transitory recording medium is not particularly limited, and may be, for example, a recording medium such as a CD-ROM or a DVD-ROM. Circuits for executing the processes to be performed by the image processing apparatus 1 may be integrated, and at least part of the image processing apparatus 1 may be configured as a semiconductor integrated circuit (a chipset or an SoC).

The phrases “based on” and “depending on” used in the present disclosure do not mean “based only on” nor “only depending on”, unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### REFERENCE SIGNS

1: Image processing apparatus
3: Printer
5: Scanner
7: Communicator
9: Operation panel
10: Image processor
11: Controller
13: Storage
20: Bus
31: Sheet feed tray
32: Sheet discharge tray
33: Scanner bed
91: Touch panel display
91a: Display
91b: Detector
103: Menu area
105: History display region
911: First display region
912: Second display region

1. An image processing apparatus comprising:
an image processor configured to execute image processing using at least one selected from the group consisting of image printing, image scanning, and image data communication;
a display having a touch panel function and configured to display an operation screen including a first display region and a second display region in which display contents related to the image processing are different from each other;
a detector configured to detect a position and a pressure level of a touch operation on the display and configured to detect the pressure level in a stepwise manner; and
a controller configured to assign, to the first display region, a single-input mode in which an acceptable pressure level of the touch operation is set at a single level, and assign, to the second display region, a multi-input mode in which an acceptable pressure level of the touch operation is set at a plurality of levels.

2. The image processing apparatus according to claim 1, wherein
the first display region is a menu area in which a plurality of function buttons corresponding to types of the image processing are arranged, and
the second display region is a history display region including a plurality of history buttons and indicating a history of the image processing which has been executed.

3. The image processing apparatus according to claim 1, wherein
each of the plurality of history buttons is configured to indicate at least one piece of information selected from the group consisting of a type of executed image processing which has been executed, a processing condition of the executed image processing, a processing date and time of the executed image processing, an execution username of the executed image processing, and a transmission destination in the executed image processing.

4. The image processing apparatus according to claim 1, wherein
the controller is configured to, when the detector detects the touch operation performed on a history button of the plurality of history buttons in the second display region, control the display to perform a display operation corresponding to the pressure level of the detected touch operation, among a plurality of display operations set for the respective pressure levels.

5. The image processing apparatus according to claim 3, wherein
the plurality of display operations includes a display operation of displaying a history use screen used for setting an image processing condition to be applied at a present time, the history use screen displaying, as an initial value, a past image processing condition corresponding to the history button on which the touch operation is detected.

6. The image processing apparatus according to claim 4, wherein
the controller is configured to, when the pressure level on the history button on which the touch operation is detected is lower than a predetermined level, control the display to perform the display operation of displaying the history use screen.

7. The image processing apparatus according to claim 3, wherein
the plurality of display operations includes an extraction display operation of displaying, side by side, only a history button of image processing whose type is identical to a type of image processing of the history button touched by a user among the plurality of history buttons.

8. The image processing apparatus according to claim 6, wherein
the controller is configured to, when the pressure level on the history button on which the touch operation is detected is equal to or higher than a predetermined level, control the display to perform the extraction display operation.

9. The image processing apparatus according to claim 3, further comprising:
a storage configured to store an image processed in the image processing which has been executed,
wherein the plurality of display operations includes an image display operation of displaying an image processed in the image processing corresponding to the history button touched by the user among a plurality of the images stored in the storage.

10. The image processing apparatus according to claim 8, wherein
the controller is configured to, when the pressure level on the history button on which the touch operation is detected is equal to or higher than a predetermined level, control the display to perform the image display operation.

11. The image processing apparatus according to claim 3, wherein
the plurality of display operations includes a display operation of displaying a condition selection screen on which an image processing condition to be applied at a present time is selected among one or more image processing conditions registered in advance for image processing whose type is identical to a type of image processing of the history button touched by the user among the plurality of history buttons.

12. The image processing apparatus according to claim 10, wherein
the controller is configured to, when the pressure level on the history button on which the touch operation is detected is equal to or higher than a predetermined level, control the display to perform the display operation of displaying the condition selection screen.

13. The image processing apparatus according to claim 3, wherein
the plurality of display operations includes a history display change operation which is any one of an operation of fixing display of the history button touched by the user at a predetermined position, an operation of releasing the fixing, and an operation of deleting the history button.

14. The image processing apparatus according to claim 12, wherein
the controller is configured to, when the pressure level on the history button on which the touch operation is detected is equal to or higher than a predetermined level, control the display to perform the history display change operation.

15. The image processing apparatus according to claim 3, wherein
the plurality of display operations includes a detail display operation of displaying detail information indicating a past image processing condition corresponding to the history button touched by the user.

16. The image processing apparatus according to claim 14, wherein
the controller is configured to, when the pressure level on the history button on which the touch operation is detected is equal to or higher than a predetermined level, control the display to perform the detail display operation.

17. The image processing apparatus according to claim 1, wherein
the controller is configured to change a setting of whether to assign the multi-input mode or the single-input mode to the first display region and/or the second display region, based on a user operation.

18. The image processing apparatus according to claim 1, wherein
the controller is configured to control the display to display, in the second display region, first identification information indicating that the multi-input mode is assigned, and/or control the display to display second identification information indicating a display operation performed when the touch operation is performed with the pressure level equal to or higher than a predetermined level in the second display region.

19. A control method for controlling an image processing apparatus configured to execute image processing using at least one selected from the group consisting of image printing, image scanning, and image data communication, the control method comprising:
assigning, to aa first display region, a single-input mode in which an acceptable pressure level of a touch operation is set at a single level;
assigning, to a second display region, a multi-input mode in which an acceptable pressure level of the touch operation is set at a plurality of levels;
displaying, by a display having a touch panel function, an operation screen including the first display region and the second display region whose display contents related to the image processing are different from each other; and
detecting, by a detector configured to detect a pressure level in a stepwise manner, a position and the pressure level of a touch operation on the display.

20. A control program causing an image processing apparatus configured to execute image processing using at least one selected from the group consisting of image printing, image scanning, and image data communication to execute:
assigning, to a first display region, a single-input mode in which an acceptable pressure level of a touch operation is set at a single level;
assigning, to a second display region, a multi-input mode in which an acceptable pressure level of the touch operation is set at a plurality of levels;
displaying, by a display having a touch panel function, an operation screen including the first display region and the second display region in which display contents related to the image processing are different from each other; and
detecting, by a detector configured to detect a pressure level in a stepwise manner, a position and the pressure level of a touch operation on the display.
